(19) United States
(12) Patent Application Publication
(10) Pub. No.: US 2007/0120363 A1
(43) Pub. Date: May 31, 2007

(54) Breaker

(76) Inventor: Han-Ming Lee, Hsin Chu City (TW)

Correspondence Address: Han-Ming Lee, P.O. BOX 7-288, TAIPEI, TW

(21) Appl. No.: 11/287,115

(22) Filed: Nov. 28, 2005

(51) Int. Cl. F16L 39/00

(52) U.S. Cl. 285/319

(57) ABSTRACT

A breaker allowing repeated safe use includes in a chamber a pin connected in series with compound metal plate, separation ring, corrugated chip, insulation ring, S conductor, dip slide block and multiple electrodes; the clip with both ends fixed on side walls in the chamber and a protruding piece disposed at the center to expose the dip slide block; two locking blocks to push the compound metal plate into conducted status; and the compound metal plate being deformed then returning to its original shape to immediately interrupt the power supply in case of abnormally high temperature due to high load.

### BACKGROUND OF THE INVENTION

(a) Field of the Invention

The present invention is related to a breaker, and more particularly to one containing a corrugated clip pushing against both sides of a compound metal on front to stay in conducted status and the compound metal is deformed then returns to its original corrugation shape to immediately interrupt the power supply in case of abnormally high temperature due to high load.

(b) Description of the Prior Art

While our life is overwhelmed with various types of home electric appliances, they become a daily necessity. Most of the appliances are equipped with plugs. The plug must be inserted into a power socket to draw the power. For safety concerns and to avoid property loss due to overload, the plug should be pulled out of the socket whenever the appliance is not in use and there are often problems with poor conduction due to that the improper connection between the blades and the socket or hazards resulted from static generated by humidity to the blades when the plug and/or the socket are damaged by yanking the power cord.

### SUMMARY OF THE INVENTION

The primary objective of the present invention is to provide a breaker that allows safe and repeated use. To achieve the purpose, the present invention is comprised of a chamber containing a locking pin connected in series with compound metal plate, separation ring, corrugated clip, insulation ring, S conduction plate, DIP slide block, and multiple electrodes.

Another purpose of the present invention is to provide a breaker that allows easy operation. To achieve the purpose, the corrugated chip has its both ends inserted and secures in respective locking slots on both sidewalls in the chamber. A protruding piece is disposed on the chip to be inserted into a dip slide block so to expose the dip side block out of a casing to achieve easy operation of the breaker by taking advantage of the repeated locking feature of the clip.

Yea another purpose of the present invention is to provide a breaker that allows highly safe and repeated use of circuit breaking for industrial purposes. To achieve this purpose, two locking blocks are respectively provided on both sides to the front of the compound metal plate in the chamber. The clip pushes into the both sides of the compound metal to hold against both locking blocks to become conducted. The compound metal plate is deformed then return to its original corrugation shape to immediately interrupt the power supply in case of abnormally high temperature due to high load.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a preferred embodiment of the present invention.

FIG. 2 is an exploded view of the preferred embodiment of the present invention.

FIG. 3 is a sectional view of a cut-away from the preferred embodiment of the present invention.

FIG. 4A and 4B is a perspective view showing that a compound metal in the preferred embodiment of the present invention is deformed and then returned to its original shape.

FIG. 5A and 5B is a plane view showing that a compound metal in the preferred embodiment of the present invention is deformed and then returned to its original shape.

FIG. 6 is a perspective view of another preferred embodiment of the present invention.

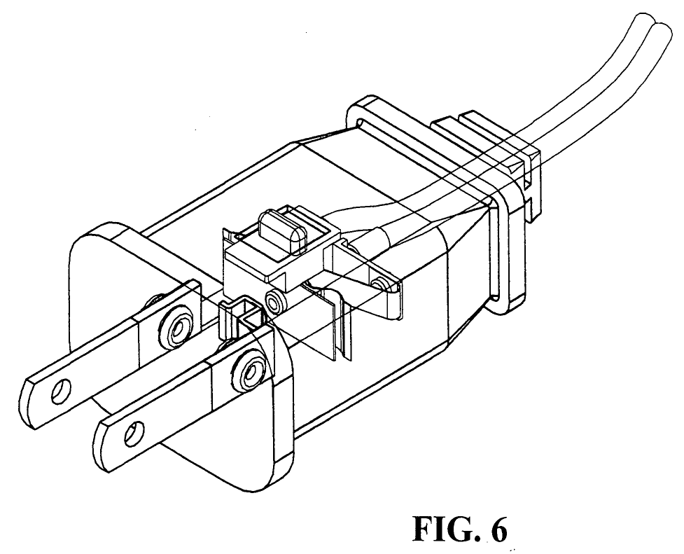

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

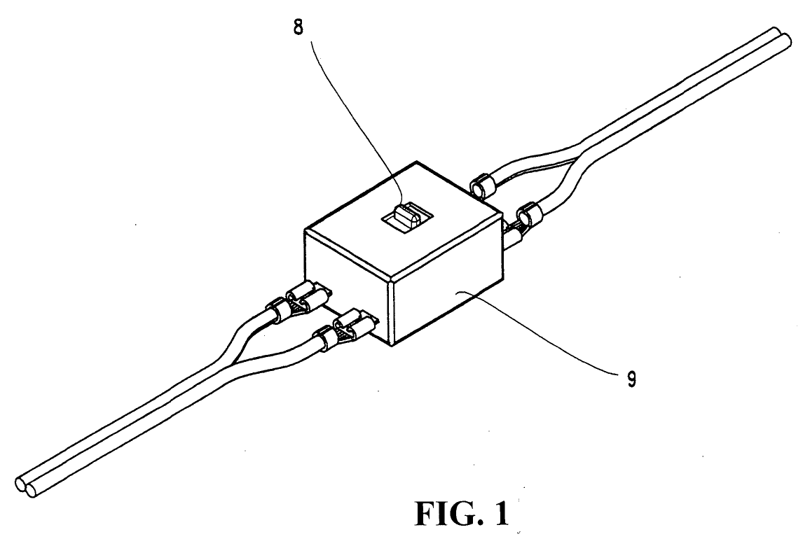

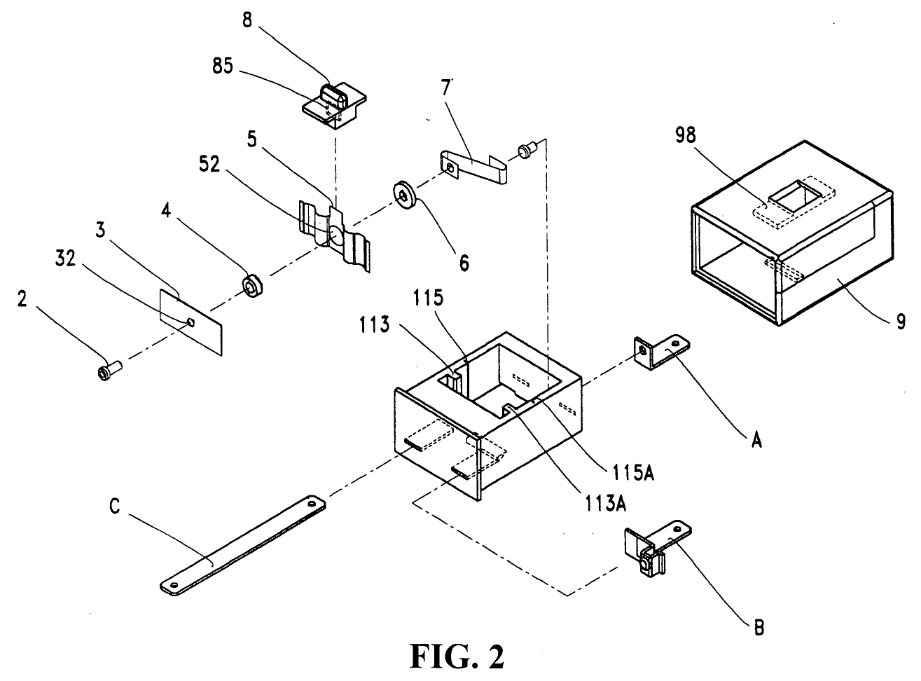

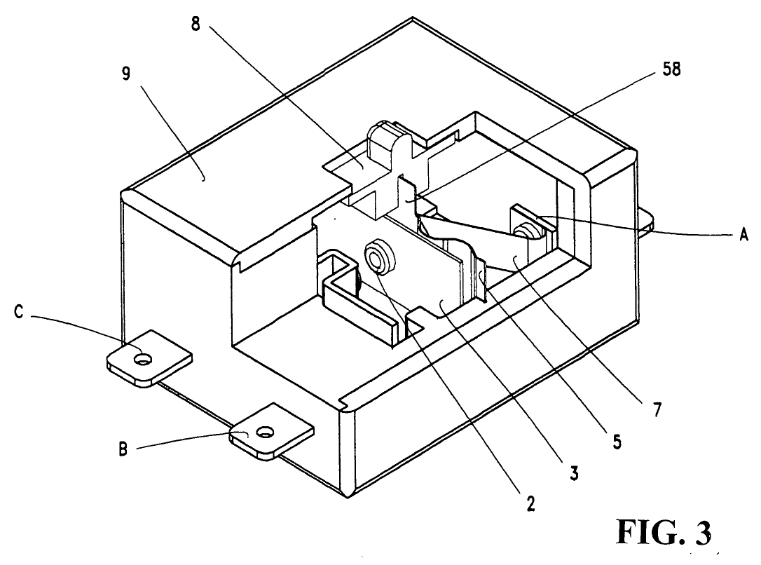

Referring to FIGS. 1, 2, and 3, a preferred embodiment of the present invention includes a main unit 1 having a chamber 11. wherein, a locking pin 2 connects in series a compound metal plate 3, a separation ring 4, a corrugates clip 5, an insulation ring. 6, an S conduction plate 7, a dip slide block 8, and multiple electrodes A, B and C before being integrated and inserted into a casing 9, the main unit 1 contains a chamber 11, two locking blocks 113, 113A respectively o both sidewalls in the chamber 11, and two corresponding locking. slots 115, 115A disposed also on both sidewalls behind their respective locking blocks 113, 113A in the chamber 11. A through hole 32 is disposed at the center of the compound metal plate 3 to receive insertion by the locking pin 2. The separation ring 4 relates to a stepped ring. A hole 52 is disposed at the center of the corrugated slip 5 to receive insertion by the inner stepped ring of the separation ring 4. Both ends of the clip 5 are respectively inserted into and secured by both locking slots 115,115A provided on both sidewalls in the chamber 11, and a protruding piece 58 extends from the clips 5. The insulation ring 6 relates to a circular ring. Holes are drilled in the front and the rear of the S conduction plate 7 to respective rivet the locking pin 2 and the electrode A. A channel 85 is drilled at where below the dip slide block 8 to receive insertion of the protruding piece 58 on the clip 5. Both of the electrodes B and C are disposed at where appropriately in the front of the main unit 1. The casing 9 related to a hollow box having on its top drilled with a notch 98 for insertion by the main unit 1.

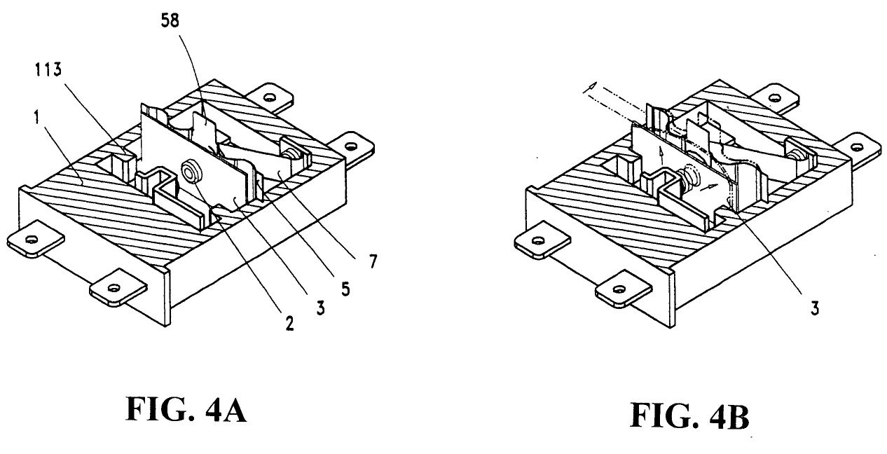

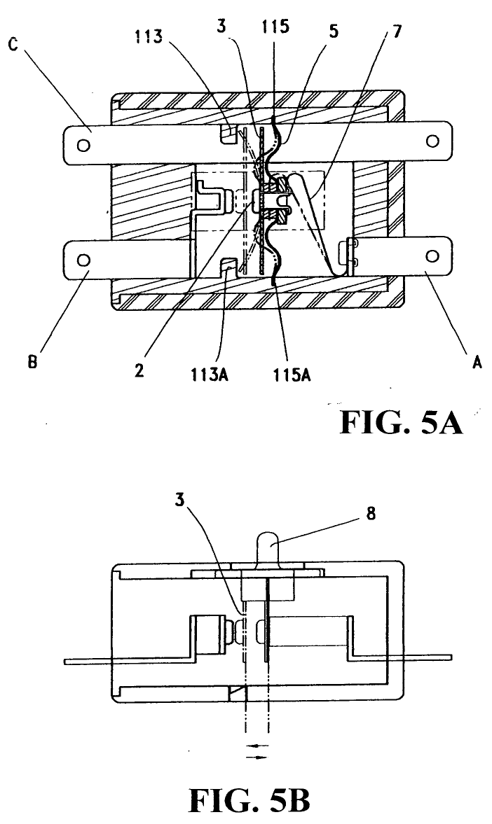

Now referring to FIGS. 4A, 4B and 5A, 5B, the dip slid block 8 pushes into the compound metal plate 5 for both sides of the compound metal plate 5 to hold against locking blocks 113,113A and to be conducted. In case of abnormal high temperature due to high load, the compound metal plate is deformed and curves before being returning to its original corrugated status to immediate interrupt the power supply, thus to provide its industrial purpose providing circuit breaking functions.

It will be understood that each of the elements described above, or two or more together many also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in ant way from the spirit of the present invention.

What is claimed is:

1. A breaker includes a main unit containing a chamber; a locking pin connecting in series compound metal plate, separation ring, corrugated clip, insulation ring, S conduction plate, dip slide block and multiple electrodes before being integrated and inserted and inserted into a casing; the main unit containing a chamber, two locking blocks and their respective locking slots being provided on both sidewalls of the chamber; a through hole being disposed at the center of the compound metal plate, and the locking pin inserting into the through hole; the separation ring related to a stepped ring; the corrugated clip having at its center disposed with a hole to receive insertion by the inner stepped ring of the separation ring, both ends of the clip being inserted and secured in both locking slots on both sidewalls in the chamber, and a protruding piece extending from the clip; the insulation ring related to a circular ring; the S conduction plate having its front and rear ends each drilled with a hole to be riveted to the locking pin and the electrode; the dip slide block having at its lower part drilled a channel to receive insertion of the protruding plate from the clip; the casing related to a hollow box having provided on its top a notch for the insertion of the main unit; two locking blocks pushing the compound metal plate into conducted status; and the compound metal plate being deformed then returning to its original corrugation shape to immediately interrupt the power supply in case of abnormally high temperature due to high load.
